(19) United States
(12) Patent Application Publication
(10) Pub. No.: US 2026/0077617 A1
(43) Pub. Date: Mar. 19, 2026

(54) Connected safety device for vehicle wheel and overall monitoring system comprising such a device

(71) Applicant: JEAN BERNARD DE LIMA, PESSAC (FR)

(72) Inventor: JEAN BERNARD DE LIMA, PESSAC (FR)

(21) Appl. No.: 18/831,168

(22) PCT Filed: Feb. 21, 2023
(86) PCT No.: PCT/EP2023/054329

§ 371 Date: Aug. 28, 2024

(30) Foreign Application Priority Data
Mar. 1, 2022 (EP) 22305233.3

(51) Int. Cl. B60B 3/16; B60R 16/03; G07C 5/00; G07C 5/02; H04W 4/48

(52) U.S. Cl. CPC B60B 3/165; B60R 16/03; G07C 5/008; G07C 5/02; H04W 4/48; B60B 2900/3312

(57) ABSTRACT

The invention relates to a connected safety device (100) intended to be mounted on a wheel (200) of a vehicle (300), notably a road transport vehicle, to prevent the fixing elements (221, 222) that connect the wheel to a hub from working loose, said device comprising rotation-blocking means (20) to prevent all or part of said fixing elements from rotating about their respective axes, locking means (40) to be secured to the wheel, at least one physical sensor (51, 52), a wireless communication module coupled to an antenna (53) to transmit data from each physical sensor on a wireless network, and an electrical power supply device (54). The invention also relates to an overall monitoring system comprising such a safety device.

### TECHNICAL FIELD

The present invention belongs to the general field of road safety, in particular safety equipment for vehicle wheels, and more particularly relates to a connected safety device, of the nut clamp type to prevent the loss of wheels, and a monitoring system comprising such a device for detecting anomalies and preventing accidents directly related to these anomalies.

The present invention has a direct, but not exclusive, application in heavy-duty vehicles such as road tractors.

### STATE OF THE ART

Road safety has always been a major issue since the generalization of road transport. Despite the considerable progress made in increasing the intrinsic safety of vehicles, road accidents caused by technical failures unfortunately remain frequent and involve all kinds of vehicles.

Accident reports show that the risk factors related to accidents, apart from human factors (fatigue, drunkenness, etc.) and environmental factors (weather conditions, road conditions, etc.), are different depending on the vehicle class (light, intermediate, heavy vehicles, etc.). In particular, the weight of a vehicle can have an amplifying effect in most accidents and thus increase their severity both on a human and material level.

In the case of heavy vehicles, typically trucks, one of the main risk factors is the loosening of the wheel fasteners on the hubs, which can cause a wheel to detach from its axle (loss of wheel) and thus a serious accident endangering the driver of the vehicle himself as well as nearby road users.

Typically, each wheel is mounted on a hub with fasteners such as screws, studs, and nuts that must be tightened to a clamping tension preset by the manufacturer. This tightening tension naturally tends to loosen over time for various reasons, mainly the movement of the wheels, especially on uneven surfaces. The more this tightening tension decreases, the more the vibrations and shocks experienced by the wheel precipitate the loosening of the fasteners until the wheel is completely disconnected.

The loosening of a lug nut can have several causes: poor roads, vibrations, poor tightening technique and/or the use of a defective tool, loosening of the wheel-hub assembly, braking and acceleration of the vehicle, human error during the assembly of the wheel, cycles of expansion and thermal contraction of the fasteners, poor wheel balancing and/or tyre pressure, various material splashes (oil, fuel, etc.) on unprotected fasteners, etc.

It should be noted that this problem of loosening lug nuts in heavy goods vehicles is well known and is a constant concern for drivers, hence the requirement for regular wheel checks and, where appropriate, the need to tighten loose nuts to the recommended tension using a torque wrench. However, given the large number of nuts per vehicle, especially for multi-axle trucks, nut inspection can quickly become a tedious and time-consuming task.

For this reason, safety devices intended to be installed directly on the nuts appeared. These devices can be simple loosening indicators that allow you to target the nuts to be tightened and thus avoid an overall check, or nut blockers that block the loosening of the nuts by limiting or preventing their clean rotation.

These security features come in different forms. Some examples are described in documents EP1981721 and EP2605921, which are in the name of the Applicant.

The known solutions all make it possible, in a more or less effective way, to block the loosening of the nuts to avoid a loss of the wheel, but in no case do they alert the driver to the warning signs occurring before the loosening, so that he can act and prevent the occurrence of accident-prone situations. Warning signs include, for example, an abnormal rise in the temperature of the nuts or an abnormal level of vibration in the wheel.

Some prior art solutions incorporate visual temperature indicators at the nuts. This is the case, for example, with the solution described in the above-mentioned document EP2605921, in which a thermochromic paint can be applied to the caps positioned opposite the nuts, so as to indicate by means of a change of colour visible to the naked 10 eye any rise in temperature beyond a certain threshold.

However, by requiring the driver to get out of the cab to inspect the wheels, this solution does not allow for any real-time alerts that can reach the driver even when they are driving their vehicle.

Therefore, there is a real need to connect this kind of safety device to the cab of the vehicle to allow real-time monitoring of the condition of the wheels, which would prevent truck drivers, whose mission is often complicated, from wasting a lot of time in the inspection of their vehicles.

It should be noted that it is known to equip a vehicle wheel with sensors, including pressure sensors placed inside the tire to monitor inflation pressure. However, such solutions do not prevent wheel loss due to loosening of the nuts and remain very far from the present invention.

### PRESENTATION OF THE INVENTION

The present invention aims to overcome the disadvantages of the state of the art described above and proposes a particularly innovative solution for equipping the wheels of a vehicle with a connected safety device communicating in real time with the driver in order to prevent accidents that can be caused by certain mechanical failures at the level of the wheels.

For this purpose, the present invention relates to a safety device intended to be mounted on a wheel of a vehicle, in particular a road transport vehicle, to prevent the loosening of the fasteners connecting the wheel to a hub, said device comprising rotating locking means to block the rotation of all or part of the said fasteners around their respective axes, and the means of locking to attach to the said wheel, remarkable in that it includes at least one physical sensor, a wireless communication module coupled with an antenna to transmit data from each physical sensor over a suitable network, and a power supply device.

This connected safety device therefore has the necessary electronic means to regularly or continuously inspect the condition of the wheel on which it is installed.

In an advantageous embodiment, the safety device shall include at least one temperature sensor, such as a thermistor, to measure the temperature at the wheel fasteners, and at least one vibration sensor, such as an accelerometer, to detect anomalies in the movement of the wheel.

Indeed, the loosening of the fasteners of a wheel is systematically manifested by abnormal variations in the temperature and vibration of the wheel, and more specifically of the rim. In view of its installation on the rim, the safety device is therefore an ideal solution for monitoring the loosening of the fasteners.

According to a particularly compact electronic architecture, the security device comprises a main electronic board integrating the wireless communication module and having processing and calculation means, in the form of a microcontroller, connected to each physical sensor, the antenna and the power supply device.

For aesthetic but also functional reasons, each physical sensor, the wireless communication module and its antenna, as well as the power supply device, are placed on a rear side of the safety device so that they are not visible when it is mounted on the wheel and are protected against the weather.

In an advantageous way of embodiment, the safety device also includes removable overheating indicators, made of thermochromic material, intended to come into contact with the wheel fasteners to indicate by a change of color any rise in temperature above a certain threshold.

The present invention also relates to a system for monitoring the condition of a wheel of a vehicle, comprising, mounted on said wheel, a safety device as shown, and at least one fixed or mobile terminal allowing a user, in particular the driver of the vehicle, to access information transmitted by said safety device.

The monitoring system may also include one or more relays suitably placed in the vehicle to improve connectivity between the safety device and the terminal, which will typically be placed in the cab.

Depending on the implementation method, the monitoring system includes a digital processing and calculation platform that can be embedded in the vehicle or remotely, notably in the form of cloud (computing).

Advantageously, the security device and the terminal are able to communicate on a wireless network adapted to the Internet of Things (LOT).

Finally, the present invention also relates to a road transport vehicle, of the heavy goods vehicle type, comprising a monitoring system as shown, wherein each wheel is equipped with a safety device.

Since the basic concepts of the invention have just been set out above in their most basic form, further details and features will become clearer from the following description and from the attached drawings, giving as a non-exhaustive example a method of embodiment of a connected safety device for a vehicle wheel and an associated monitoring system, in accordance with the principles of the invention.

### BRIEF DESCRIPTION OF THE FIGURES

The figures are given for illustrative purposes only for a better understanding of the invention without limiting its scope. The individual elements are represented schematically and are not necessarily to scale. On all the figures, the identical or equivalent elements bear the same numerical reference.

It is illustrated in:
FIG. 1: a vehicle whose wheels are equipped with safety devices according to the invention;
FIG. 2: a vehicle wheel equipped with a safety device;
FIG. 3: a partial front view of the safety device installed on the wheel, with the detail of a means of blocking around a wheel fastening element;
FIG. 4a: A front view of the safety device showing the color change of an overheat indicator;
FIG. 4b: a partial rear view of the safety device with the hub studs;
FIG. 5a: a front perspective view of an overheating indicator according to the invention;
FIG. 5b: a rear-view view of the overheat indicator;
FIG. 6: a diagram of the safety device with its sensors and integrated electronic components;
FIG. 7: an electronic architecture of the security system;
FIG. 8: a diagram of a surveillance system implementing the safety devices according to the invention;
FIG. 9: a flowchart of the main steps of a monitoring method implementing a monitoring system according to the invention;
FIG. 10: An example of a dashboard displayed on the driver's terminal;
FIG. 11: an example of a measurement window displaying the temperature variation;
FIG. 12: An example of the location of a fixed terminal in the vehicle cab.

### DETAILED DESCRIPTION OF EMBODIMENTS

It should be noted that certain technical elements well known to the skilled person are recalled here in order to avoid any inadequacy or ambiguity in the understanding of this description.

In the embodiment described below, reference is made to a connected safety device for vehicle wheels, intended primarily for a heavy vehicle to monitor the condition of each of its wheels and prevent it from detaching from the axle. This example, which is not exhaustive, is given for a better understanding of the invention and does not exclude the use of the said device on a vehicle of another type (buses, coaches, certain quarry and mining vehicles and other industrial vehicles), as long as it is a wheeled vehicle in which each wheel is mounted on an axle by fasteners liable to loosen. In this description, an object is said to be “connected>> when it is equipped with means capable of communicating, autonomously, with other connected objects on a wireless network.

FIG. 1 shows 100 connected safety devices, each mounted on a 200 wheel of a 300 vehicle, which, according to the example shown, is of the single-trailer articulated road tractor type. Each 100 safety device is equipped with sensors and able to communicate wirelessly with the cab of the 300 vehicle to inform the driver in real time of the status of the 200 wheel on which it is installed.

According to the embodiment illustrated, the connected safety device 100 is obtained by integrating functional electronics (sensors, power supply and wireless means of communication) with a known safety device, in particular the one described in the document EP2605921 in the name of the Applicant and marketed under the registered trademark Sécuriveur®.

Compared to the aforementioned safety device, the connected safety device 100 does not have any major structural or mounting differences on the wheel, so no detailed reminder will be made in this description. Nevertheless, a brief overview is necessary for the future.

With reference to FIG. 2, the safety device 100 is attached in a familiar way to the rim 210 of the 200 wheel to lock the fasteners connecting the wheel to the hub in rotation. Safety device 100 consists of caps 10 and 15 distributed in a circular manner so that they come in front of the fasteners to conceal them, like a classic hubcap.

FIG. 3 shows the safety device 100 mounted on the wheel, without the rim or tyre, on which a cap 15 has been placed in transparency to make the fastener blocked in rotation visible. Behind each cap 10 and 15 is a wheel fastener, in this case a conventional bolt

consisting of a nut 221 screwed onto a stud 222 attached to the hub, which is locked in rotation by a locking means 20 of the safety device 100, said locking means being shaped to block the rotation of the nut 221 around its clamping axis and for that purpose comprises a inner profile 21 of suitable shape (combined with the sides of the nut or any other shape ensuring the rotating locking of the nut) and an external profile of also suitable shape to block its own rotation in the safety device 100.

FIGS. 4a and 4b represent the safety device 100 in front and rear view, and make it possible to account for the rotating blocking of the blocking means 20 themselves, in particular by means of their roughly square external profile which, when it is sufficiently large, butts up against the internal walls 31 and 32, of the main body 30 of the said device. In FIG. 4b, safety device 100 is shown with the insulated studs 222, the front faces of which are visible, without the wheel rim or the holding plates that allow the locking means 20 to be pressed against the rear face 33 of the said device.

Finally, the safety device 100 is attached to the wheel with mechanical locking means 40.

Of course, the above-mentioned elements of safety device 100 are described in more detail in document EP2605921.

The first improvement brought about by the present invention lies in the replacement of all or part of the old metal caps 10, whose function is mainly aesthetic, by new caps 15 capable of indicating a temperature level, hereinafter referred to as “overheating indicators”.

The 15 overheat indicators are made of a thermochromic material that changes color depending on the temperature (see 15* in FIG. 4a). This allows the driver to easily see the overheating areas on the wheel and carry out the necessary maintenance.

Each overheat indicator 15 is in contact with a wheel fastener, such as the face of the nut 221 or the end of the stud 222 in the vicinity.

FIGS. 5a and 5b show an overheating warning light 15 comprising a front face 151, visible when the warning light is installed on the safety device 100, and a rear face 152 intended to come into contact with the fastener. In view of the design of the safety device 100, in particular the presence on its front side 34 of holes leading to the wheel fasteners, the overheating warning lights 15 are of a shape adapted to fit elastically into the said holes, and include an annular corolla 153 which rests on the said front face. This corolla 153 also facilitates the manual removal of the overheat indicator 15.

Preferably, the 15 overheat indicators have a certain flexibility that makes them easy to apply and remove on the 100 safety device.

The 15 overheat indicators can also melt under the effect of heat, beyond a certain temperature threshold.

The temperature rise that a wheel fastener may experience may, among other things, be due to the loosening of the wheel. Indeed, loosening increases mechanical play and, by the same token, friction. As a result, the overheat tell-tales 15 are indirectly indicators of loosening and allow the driver to identify any loosening, or any other failure that is manifested by an increase in temperature, by a simple visual check of the colour of the tell-tales.

The rise in temperature can also be due to bearing degradation, brake block malfunction, tyre heating, ambient temperature, etc.

In order to improve the detection of anomalies in the wheels and thus to enhance the safety of the vehicle, the present invention provides a second improvement by integrating sensors and wireless means of communication into the safety device 100 allowing it to inform the driver in real time of the condition of the wheels of his vehicle.

FIG. 6 shows safety device 100 by showing schematically some possible locations for various sensors and electronic components, including temperature sensors 51, vibration sensors 52, an antenna 53, a power supply device 54

and an electronic board 55 equipped with a wireless communication module and one or more sensors.

Temperature sensors are used to measure the temperature on the hub and must be positioned as close as possible to the heat source to provide accurate measurements. Preferably, the temperature sensors 51 are positioned at the two locking means 40 of the safety device 100, where the temperature is highest in relation to the heat conduction path from the hub to the said device.

51 temperature sensors can be with or without contact, preferably with contact due to lower sensitivity to the environment (dirt, dust, etc.), energy consumption and cost.

In view of the temperatures that can be reached by the metal surfaces of the 40 locking media, the 51 temperature sensors preferably have a measuring range of −40 to 150° C.

For example, the 51 temperature sensors are thermistors that are particularly suitable for easy attachment and integration to the 100 safety device.

The safety device may also include ambient temperature sensors to calibrate the thresholds for triggering alerts according to weather conditions.

The 52 vibration sensors measure the movement of the part to which they are attached, along several axes, so as to allow the detection of mechanical anomalies due to wear of the parts.

Each 52 vibration sensor can be a miniature Inertial Measurement Unit (IMU). Such a unit is generally made up of an association of sensors, known as proprioceptives, which directly measure the movements of the mobile to which the unit is attached. Such sensors are accelerometers and gyrometers. For reasons of miniaturization, these sensors are designed according to microelectromechanical system (MEMS) technology, for example.

Preferably, each vibration sensor 52 has an accelerometer, a gyrometer and, incidentally, a magnetometer.

Each vibration sensor 52 can be equipped with an integrated computer in the form of a microcontroller, which successively integrates the measured accelerations to obtain the components of the linear velocity vector as well as the position. Thus, the analysis of the position in relation to the different measuring axes makes it possible to deduce the vibration level of the safety device 100 and therefore of the wheel on which the device is installed, and to detect anomalies thanks to specific algorithms calibrated according to the vehicle.

In addition, the 52 vibration sensors have a motion (activity) detection function that allows them to be put on standby when the vehicle is stationary to reduce their energy consumption.

For example, the 52 vibration sensors are so-called 6-axis accelerometers with a wide programmable operating range (2 g to 32 g on 16 bits) and a maximum sampling rate of 6.66 kHz.

The use of accelerometers makes it possible, by measuring the position, to identify each wheel in the vehicle to facilitate interaction with the driver.

The temperature 51 and vibration 52 sensors are connected to the electronic board 55 which has a wireless communication module, e.g. radio frequency, coupled to the transmit/receive antenna 53 which is correctly placed on the safety device 100.

Preferably, the wireless communication module transmits on an ISM (Industrial, Scientific and Medical) frequency band, in particular on LoRa or Sigfox networks, which are particularly suitable for short ranges and low-power connected objects.

This allows the 53 antenna to be of the printed circuit board (PCB) type designed to be flexible and adapt to many surfaces. In particular, the antenna has an adhesive to be attached to the safety device 100.

Power supply device 54 provides the electrical energy necessary for the operation of the aforementioned electronic components, and may include an energy harvesting system (solar, vibrational, electromechanical, magnetic, etc.) and/or a battery such as a lithium-ion battery.

Preferably, the power supply device 54 includes one or more batteries.

In order to comply with the operating temperature range of the 54 battery, it is thermally insulated from the “hot” parts of the 100 safety device, for example by adding a special insulation layer.

Of course, according to other embodiments, the connected safety device 100 includes other sensors and other easements to improve the overall safety of the vehicle. For example, the safety device 100 may have a motion detector on its front panel, preferably infrared, and placed on a wheel near a sensitive area (fuel tank) of the vehicle to detect and signal the very close presence of an individual when the vehicle is parked, for example. This would make it possible to secure the vehicle against theft and damage to equipment, especially at night when the driver is less vigilant.

The safety device can also include blind spot detectors at the rear wheels, for example.

FIG. 7 shows an example of an electronic architecture in which the connected safety device 100 comprises two thermistor-type temperature sensors 51, three accelerometers, one of which 52 is connected to the main electronic board 55 by a cable and the other two 552 integrated into the said board, an antenna 53 and at least one lithium-ion battery 54.

The 55 main electronic board centralizes all the services necessary for the operation of all sensors and electronic components, such as energy management and control units, data transmission, wireless communication, etc. In particular, the 55 board includes a 551 processing and computing unit in the form of a microcontroller that allows both the acquisition of sensor data and its transmission over a wireless network to a receiver located in the vehicle's cabin.

According to the architecture in FIG. 7, the electronic components can be positioned at different locations on the safety device 100, as long as their performance is not greatly reduced.

Equipped with the aforementioned sensors and electronic components, the connected safety device 100 is capable of probing the condition of the wheel on which it is attached and informing the driver of the vehicle directly or indirectly by transmitting the data through a digital processing platform, which can be in the form of a cloud, before it arrives, in a usable form, on a driver's

terminal. Thus, all 100 connected safety devices in a vehicle can work in a more comprehensive monitoring system.

FIG. 8 schematizes the operating principle of the connected safety device 100 within such a monitoring system, which includes a relay 310 placed at vehicle level 300, a network antenna 400, an external analysis and storage platform 500 and various terminals 350 and personal means of communication and assistance, the latter of which can be fixed and placed in the cab of the vehicle.

The presence of the 400 network antenna and the 500 external platform is not mandatory in the monitoring system, which can be completely autonomous. Indeed, the data from the 100 safety devices can be transmitted directly to a 350 terminal placed in the cabin, with or without a 310 relay depending on the connectivity available, the said terminal can then process the data received autonomously with an on-board computing capacity.

Alternatively, for reasons of data sharing within a community of users (collaborative platform) for example, remote data processing may be used according to the operation described below.

Initially, the 100 connected safety devices, via their various sensors, perform data acquisition in the form of measurements and detections of 200 wheel parameters (temperature, vibrations, etc.), which are then transmitted to the 500 analysis platform through the 400 antenna before being communicated in raw form or modified to the 350 user terminals.

When the 310 relay uses a wireless communication module that includes an expansion card for a specific network, the 400 antenna corresponds to an antenna of that network. For example, the 400 antenna is a long-range radio antenna associated with an Internet of Things (LOT) operator.

Of course, other mobile phone networks can be used in the context of the invention.

The 500 platform mainly includes a data storage system, one or more computer servers, processing and calculation resources implementing algorithms, particularly artificial intelligence, and an API (Application Programming Interface) application

programming interface (API) to link a local program to consumer programs executed on 350 user terminals. fixed or mobile, such as a computer, a digital tablet or a smartphone. The 500 platform can be physical or, preferably, virtual, in which case it has a virtualization layer that includes all or part of the above, including the storage system and servers, so as to obtain a cloud architecture, commonly referred to as “>>cloud computing”, providing that platform with advantageous agility and computing capacity.

Thus, the 500 platform is accessible through an internet-like network and can be in the form of software as a service (Saas), or as a provider program accessible via the API by consumer programs. Preferably, the 500 platform is a web-based SaaS.

The surveillance system thus described, consisting mainly of the 100 connected safety devices, a 350 cab terminal and an on-board or cloud-based processing platform, allows the driver to monitor the status of his vehicle in real time, detect anomalies and prevent accidents, by implementing an appropriate monitoring process.

FIG. 9 shows the main steps of such a 600 monitoring process, which includes:
an initial 610 stage of data collection;
a step 620 for the transmission of the collected data to a processing platform;
a 630 data processing step;
a 640 step for displaying the processed data via a dedicated interface;
a conditional 650 anomaly detection step;
a 655 stage of real-time alert in the event of an anomaly;
a 660 step to recommend one or more appropriate actions. The initial 610 step of data collection is to bring together all the data from the various sensors in the 100 safety devices. Sensor measurements can be carried out continuously or periodically for a set period of time. The choice may depend on the nature of the sensors, their energy consumption, their criticality in the safety of the vehicle, etc.

Of course, some data can be collected in deferred time, at regular time intervals or at the request of the driver.

The data collected is then transmitted to the digital processing platform.

The 620 data transmission step is preferably carried out in real time for optimal monitoring of the evolution of the various wheel parameters. This transmission is necessarily carried out on a secure channel or channels and may use signal encoding or encryption techniques.

Step 630 of data processing consists of running a series of calculations and analyses to make the collected data actionable and to enable the driver to take the necessary actions to optimize the maintenance of his vehicle.

This processing step is implemented by the digital platform's computing resources, implementing, among other things, artificial intelligence algorithms to carry out predictive analyses.

More specifically, machine learning models can predict the occurrence of failures such as loosening nuts, but also recommend actions based on historical data and interventions available for the said vehicle or from another similar vehicle.

The results of the various processes are then displayed on a dashboard in display step 640.

The dashboard is accessible from the cab terminal and allows the driver to access information in real time.

FIG. 10 shows an example of the home page of a 351 dashboard that can be accessed from a web page, for example (secure access to a user space). The 351 Dashboard is a graphical interface tailored to each user and includes components to facilitate airworthiness, access to information and monitoring.

Overall, this dashboard includes the main headings, indicated by 352 tabs with pictograms for example, here ALERTS, VEHICLE, WHEELS and MEASURES. The 351 dashboard can additionally have a 353 search bar for quick access to a specific piece of data, additional buttons 354 customizable tools, as well as any other components or interface tools that simplify the use of the dashboard.

Thus, the dashboard allows access to the various data processing carried out, but above all to monitor alert cases in real time and to offer the driver a means of immediate communication to manage these alerts.

FIG. 11 shows an example of a real-time temperature measurement window on a given wheel of the vehicle.

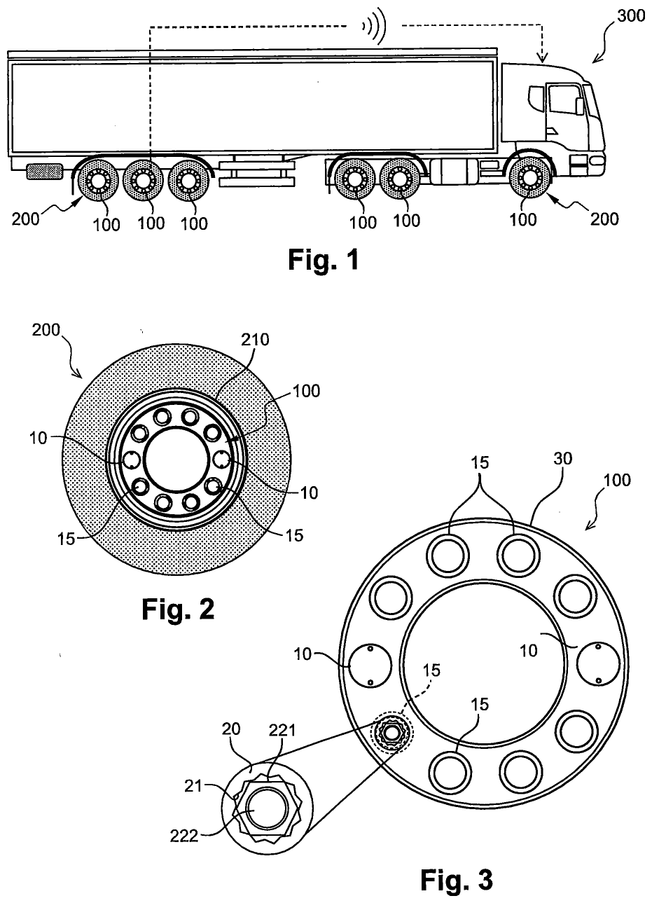

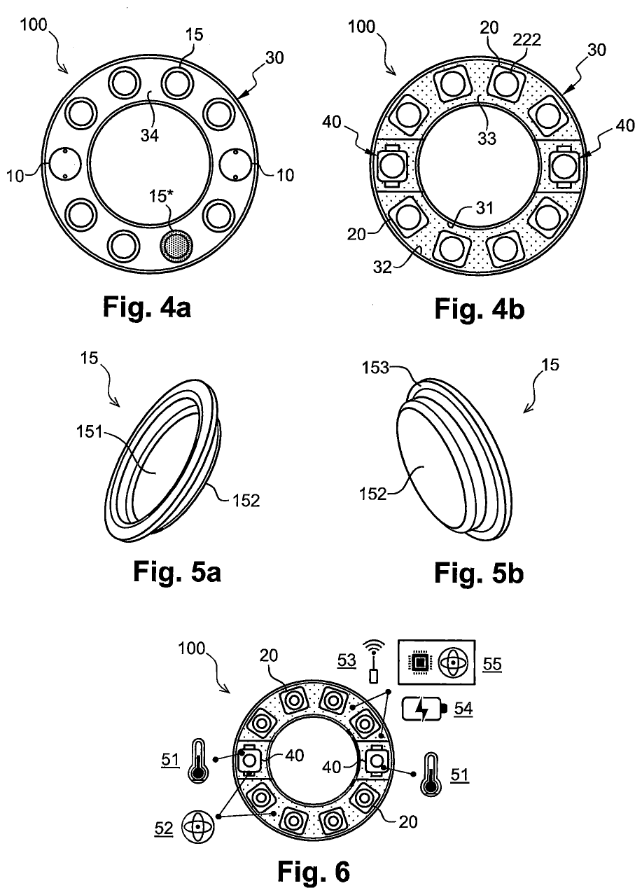

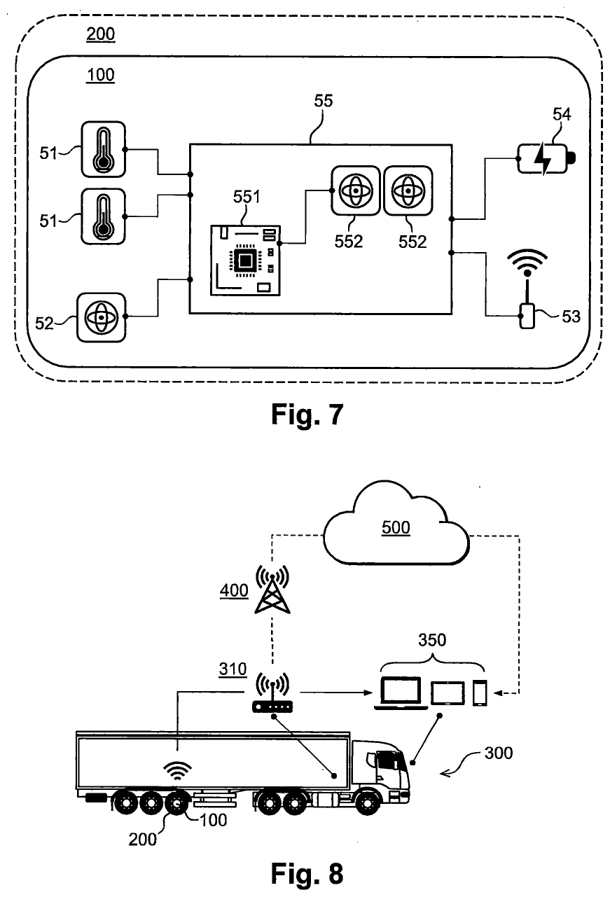

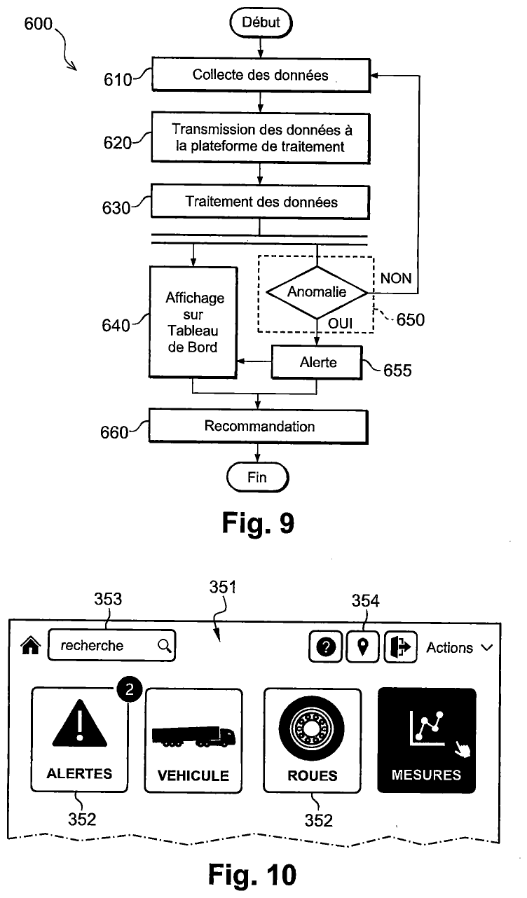

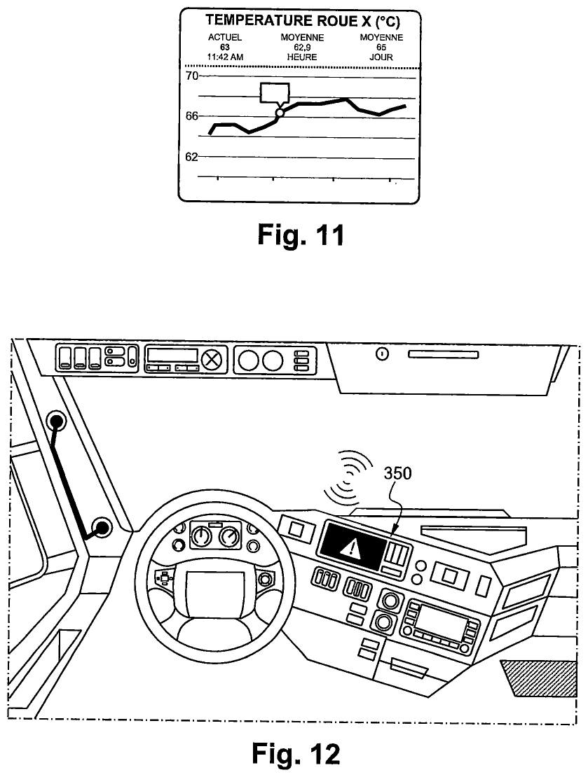

FIG. 12 shows a possible location of Terminal 350 in the cab of the vehicle so that it is within immediate reach of the driver. In addition to the visual notifications of the alerts as shown in FIG. 12, the alerts can also be audible to capture the driver's attention when they are watching the road ahead and not necessarily paying attention to the 350 terminal display.

It is apparent from this description that certain elements of the safety device can be replaced by equivalent elements without going beyond the scope of the invention. For example, the safety device can be achieved by integrating the same electronics (sensors, wireless communications and power supply) into a traditional hubcap that does not have means of rotating locking the wheel fasteners.

1. A safety device (100) intended to be mounted on a wheel (200) of a vehicle (300), in particular a road transport vehicle, to prevent the loosening of the fastening elements (221, 222) connecting the wheel to a hub, said device comprising rotation locking means (20) to prevent the rotation of all or part of said fastening elements around their respective axes, and locking means (40) to be secured to said wheel, characterized in that it comprises at least one physical sensor (51, 52), a wireless communication module coupled to an antenna (53) for transmitting data from each physical sensor over a wireless network and a power supply device (54).

2. Safety device according to claim 1, comprising at least one temperature sensor (51), for measuring the temperature at the level of the fixing elements (221, 222) of the wheel (200), and at least one vibration sensor (52) for detecting anomalies in the movement of said wheel.

3. Security device according to claim 1 or 2, comprising a main electronic card (55) integrating the wireless communication module and having processing and calculation means, in the form of a microcontroller, connected to each physical sensor (51, 52), to the antenna (53) and to the electrical power supply device (54).

4. Safety device according to any one of the preceding claims, in which each physical sensor (51, 52), the wireless communication module and its antenna (53) as well as the power supply device (54) are placed on a rear face of said safety device so that they are not visible when the latter is mounted on the wheel (200).

5. Safety device according to any one of the preceding claims, further comprising removable overheating indicators (15) intended to come into contact with the fixing elements (221, 222) of the wheel (200), said indicators being made of a thermochromic material.

6. System for monitoring the condition of a wheel (200) of a vehicle (300), characterized in that it comprises, mounted on said wheel, a safety device (100) according to one of claims 1 to 5, and at least one fixed or mobile terminal (350) allowing a user, in particular a driver of the vehicle, to access information transmitted by said safety device.

7. A monitoring system according to claim 6, further comprising a relay (310) suitably located in the vehicle (300) to improve connectivity between the security device (100) and the terminal (350).

8. Monitoring system according to claim 6 or 7, further comprising a digital processing and calculation platform (500), said platform being able to be embedded in the vehicle (300) or remotely, in particular in the form of a cloud.

9. Surveillance system according to any one of claims 6 to 8, in which the security device (100) and the terminal (350) are capable of communicating on a wireless network adapted to the Internet of Things.

10. Road transport vehicle (300), of the heavy goods vehicle type, characterized in that it comprises a monitoring system according to one of claims 6 to 9, in which each wheel (200) is equipped with a safety device (100).
